(19) United States
(12) Patent Application Publication
(10) Pub. No.: US 2014/0327594 A1
(43) Pub. Date: Nov. 6, 2014

(54) APPARATUS AND METHOD FOR MATCHING IMPEDANCE

(71) Applicant: SAMSUNG ELECTRONICS CO., LTD, Suwon-si (KR)

(72) Inventors: Yaming Zhang, Plano, TX (US); Lup Meng Loh, Plano, TX (US); William Hurley, Murphy, TX (US); John Alex Interrante, Richardson, TX (US)

(73) Assignee: Samsung Electronics Co., LTD, Suwon-si (KR)

(21) Appl. No.: 13/875,411

(22) Filed: May 2, 2013

(51) Int. Cl. H01Q 1/50

(52) U.S. Cl. CPC H01Q 1/50
USPC 343/861

(57) ABSTRACT

An apparatus for matching impedance for use in a wireless communication is provided. The apparatus includes a forward path carrying a transmission signal to an antenna. The apparatus further comprises a quadrature feedback path configured to extract and feed back in-phase and quadrature phase components from each of a forward signal being transmitted toward the antenna and a reverse signal reflected from the antenna. A tunable matching network (TMN) is coupled to the forward path, having a plurality of tunable elements for matching an internal impedance to an impedance of the antenna. A controller is configured to calculate TMN input impedance's amplitude and phase based on the in-phase and quadrature phase components from each of the forward signal and the reverse signal.

### TECHNICAL FIELD

The present application relates generally to an apparatus and a method for impedance matching and, more specifically, to an impedance matching transmitter with quadrature feedback circuitry.

### BACKGROUND

New mobile phones are being developed with the aim of integrating more frequency bands and operating modes while at the same time minimizing power consumption. The combination of these bands and operating modes requires complex RF front ends, because each frequency band needs its own specific hardware. This means that the number of components as well as the space requirement on the circuit board increase, as does the power dissipation of the RF front end. To obtain maximum radiation/sensitivity to meet stringent carrier RF performance specifications, λ/4 structure length is desired, which unfortunately, is leading to a large antenna volume. However, the large display and battery sizes have reduced the available space for the phone antenna. At the same time, mobile phones are being equipped with an increasing number of additional functions such as cameras, MP3 players, radios and TV tuners. As mobile phones are becoming ever smaller, the antennas incorporated in them must also be more compact. Currently, internal low volume planar antennas acting as a resonance circuit are largely used for this purpose. Their drawback is that their near field reacts with excessive sensitivity to external effects such as interactions with the mobile phone users. These change the antenna impedance considerably, with a correspondingly strong impact on the transmitting and receiving quality. Various mobile phone features such as flip or slider phones, movable keypads and displays further complicate the antenna's performance because the varied common-ground loads also affect its impedance.

When the input impedance of antenna varies, there is a mismatch between the power module and the antenna, with two major effects: firstly, the power module will not perform at optimal efficiency under load variations; and secondly, the radiated power decreases due to the reflected power, so the equipment has to increase the power to compensate for the reduction. The result is an increase in the energy consumption (i.e., decreased battery endurance) or transmission quality deterioration. In addition, the power module could be damaged if the reflection of the signal levels is excessively high and no isolator is used.

### SUMMARY

An apparatus for matching impedance for use in a wireless communication is provided. The apparatus includes a forward path carrying a transmission signal to an antenna. The apparatus further includes a quadrature feedback path configured to extract and feed back in-phase and quadrature phase components from each of a forward signal being transmitted toward the antenna and a reverse signal reflected from the antenna. A tunable matching network (TMN) is coupled to the forward path, having a plurality of tunable elements for matching an internal impedance to an impedance of the antenna. A controller is configured to calculate TMN input impedance's amplitude and phase based on the in-phase and quadrature phase components from each of the forward signal and the reverse signal.

A method for matching impedance for use in a wireless communication is provided. The method includes detecting, on a forward path carrying a transmission to an antenna, a forward signal transmitted toward the antenna and a reverse signal reflected from the antenna. The method also includes extracting and feeding back in-phase and quadrature phase components from each of the forward signal and the reverse signal via a quadrature feedback path. In addition, the method includes determining an amplitude and phase of input impedance of a tunable matching network (TMN) with a plurality of tunable elements, based on the in-phase and quadrature phase components from each of the forward signal and the reverse signal. The method further includes configuring the TMN to have the determined input impedance's amplitude and phase by tuning the tunable elements.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless communication network, according to embodiments of the present disclosure;

FIG. 2A is a high-level diagram of an orthogonal frequency division multiple access (OFDMA) or millimeter wave transmit path, according to embodiments of the present disclosure;

FIG. 2B is a high-level diagram of an OFDMA or millimeter wave receive path, according to embodiments of the present disclosure;

FIG. 3 illustrates a subscriber station according to embodiments of the present disclosure;

FIG. 4 illustrates a transmitter with adaptive antenna matching tuning unit according to embodiments of the present disclosure;

FIG. 5 illustrates a transmitter with qudrature feedback circuitry according to embodiments of the present disclosure;

FIG. 6 illustrates a Tunable Matching Network (TMN) according to embodiments of the present disclosure; and

FIG. 7 illustrates a high-level flow chart of a process for matching impedance according to embodiments of the present disclosure.

### DETAILED DESCRIPTION

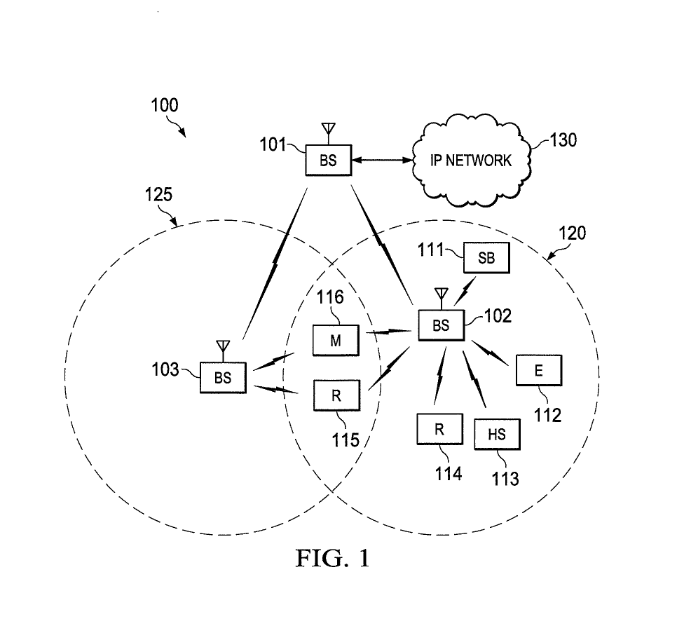

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices.

FIG. 1 illustrates a wireless communication network, according to embodiments of the present disclosure. The embodiment of wireless communication network 100 illustrated in FIG. 1 is for illustration only. Other embodiments of the wireless communication network 100 could be used without departing from the scope of the present disclosure.

In the illustrated embodiment, the wireless communication network 100 includes base station (BS) 101, base station (BS) 102, base station (BS) 103, and other similar base stations (not shown). Base station 101 is in communication with base station 102 and base station 103. Base station 101 is also in communication with Internet 130 or a similar IP-based system (not shown).

Base station 102 provides wireless broadband access (via base station 101) to Internet 130 to a first plurality of subscriber stations (also referred to herein as mobile stations) within coverage area 120 of base station 102. Throughout the present disclosure, the term mobile station (MS) is interchangeable with the term subscriber station (SS). The first plurality of subscriber stations includes subscriber station 111, which may be located in a small business (SB), subscriber station 112, which may be located in an enterprise (E), subscriber station 113, which may be located in a WiFi hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access (via base station 101) to Internet 130 to a second plurality of subscriber stations within coverage area 125 of base station 103. The second plurality of subscriber stations includes subscriber station 115 and subscriber station 116. In an exemplary embodiment, base stations 101-103 may communicate with each other and with subscriber stations 111-116 using OFDM or OFDMA techniques including techniques for: closed-loop adaptive impedance matching tuning as described in embodiments of the present disclosure.

Each base station 101-103 can have a globally unique base station identifier (BSID). A BSID is often a MAC (media access control) ID. Each base station 101-103 can have multiple cells (e.g., one sector can be one cell), each with a physical cell identifier, or a preamble sequence, which is often carried in the synchronization channel.

While only six subscriber stations are depicted in FIG. 1, it is understood that the wireless communication network 100 may provide wireless broadband access to additional subscriber stations. It is noted that subscriber station 115 and subscriber station 116 are located on the edges of both coverage area 120 and coverage area 125. Subscriber station 115 and subscriber station 116 each communicate with both base station 102 and base station 103 and may be said to be operating in handoff mode, as known to those of skill in the art.

Subscriber stations 111-116 may access voice, data, video, video conferencing, and/or other broadband services via Internet 130. For example, subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer (PC), a laptop computer, a gateway, or another device.

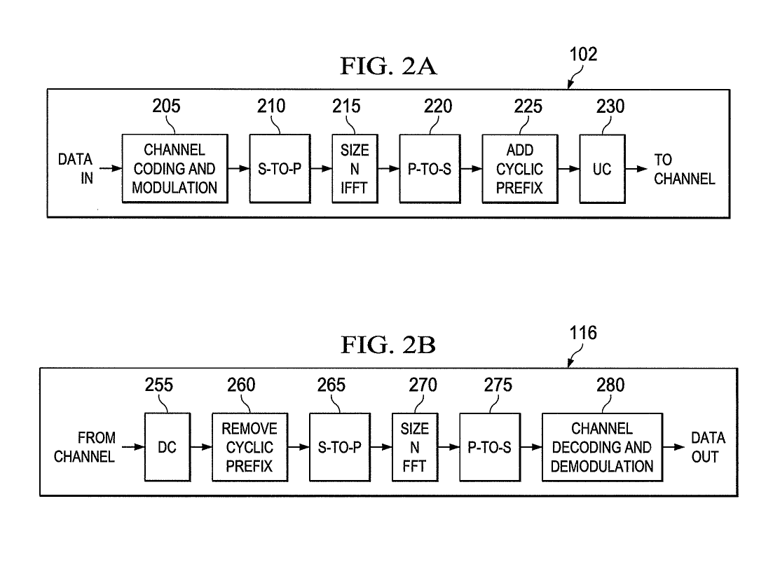

FIG. 2A is a high-level diagram of an orthogonal frequency division multiple access (OFDMA) or millimeter wave transmit path, according to embodiments of the present disclosure. FIG. 2B is a high-level diagram of an OFDMA or millimeter wave receive path, according to embodiments of the present disclosure. In FIGS. 2A and 2B, the transmit path 200 may be implemented, e.g., in base station (BS) 102 and the receive path 250 may be implemented, e.g., in a subscriber station, such as subscriber station 116 of FIG. 1. It will be understood, however, that the receive path 250 could be implemented in a base station (e.g. base station 102 of FIG. 1) and the transmit path 200 could be implemented in a subscriber station. All or part of the transmit path 200 and the receive path 250 may comprise, or be comprised of, one or more processors.

Transmit path 200 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. Receive path 250 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B may be implemented in software while other components may be implemented by configurable hardware or a mixture of software and configurable hardware. In particular, it is noted that the FFT blocks and the IFFT blocks described in the present disclosure document may be implemented as configurable software algorithms, where the value of Size N may be modified according to the implementation.

Furthermore, although the present disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In transmit path 200, channel coding and modulation block 205 receives a set of information bits, applies coding (e.g., LDPC coding) and modulates (e.g., Quadrature Phase Shift Keying (QPSK) or Quadrature Amplitude Modulation (QAM)) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at SS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

In one embodiment of the present disclosure, abase station (BS) can have one or multiple cells, and each cell can have one or multiple antenna arrays, where each array within a cell can have different frame structures, e.g., different uplink and downlink ratios in a time division duplex (TDD) system. Multiple TX/RX (transmitting/receiving) chains can be applied in one array, or in one cell. One or multiple antenna arrays in a cell can have the same downlink control channel (e.g., synchronization channel, physical broadcast channel, and the like) transmission, while the other channels (e.g., data channel) can be transmitted in the frame structure specific to each antenna array.

The base station can use one or more antennas or antenna arrays to carry out beam forming. Antenna arrays can form beams having different widths (e.g., wide beam, narrow beam, etc.). Downlink control channel information, broadcast signals and messages, and broadcast data channels and control channels can be transmitted in wide beams. A wide beam may include a single wide beam transmitted at one time, or a sweep of narrow beams at sequential times. Multicast and unicast data and control signals and messages can be transmitted in narrow beams.

Identifiers of cells can be carried in the synchronization channel. Identifiers of arrays, beams, and the like, can be implicitly or explicitly carried in the downlink control channels (e.g., synchronization channel, physical broadcast channel, and the like). These channels can be sent over wide beams. By acquiring these channels, the mobile station (MS) can detect the identifiers.

A mobile station (MS) can also use one or more antennas or antenna arrays to carry out beam forming. As in BS antenna arrays, antenna arrays at the MS can form beams with different widths (e.g., wide beam, narrow beam, etc.). Broadcast signals and messages, and broadcast data channels and control channels can be transmitted in wide beams. Multicast and unicast data and control signals and messages can be transmitted in narrow beams.

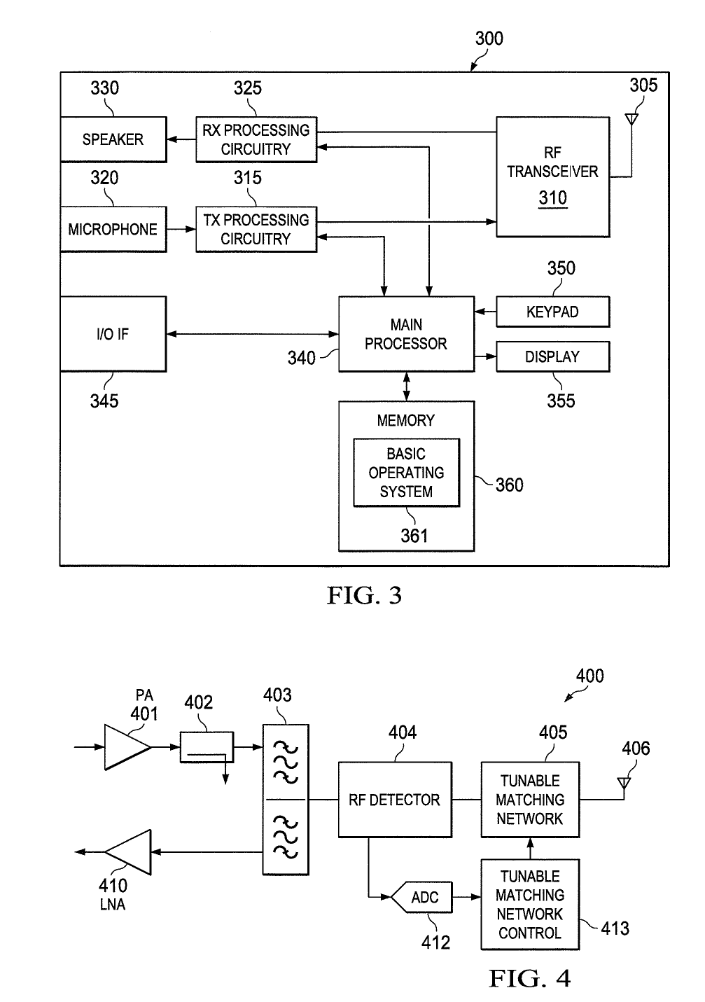

FIG. 3 illustrates a subscriber station according to an exemplary embodiment of the disclosure.

In certain embodiments, main processor 340 is a microprocessor or microcontroller. Memory 360 is coupled to main processor 340. According to some embodiments of the present disclosure, part of memory 360 comprises a random access memory (RAM) and another part of memory 360 comprises a Flash memory, which acts as a read-only memory (ROM).

Main processor 340 executes basic operating system (OS) program 361 stored in memory 960 in order to control the overall operation of wireless subscriber station 116. In one such operation, main processor 340 controls the reception of forward channel signals and the transmission of reverse channel signals by radio frequency (RF) transmitter 910, receiver (RX) processing circuitry 325, and transmitter (TX) processing circuitry 315, in accordance with well-known principles.

Main processor 340 is capable of executing other processes and programs resident in memory 360, such as operations for closed-loop adaptive impedance matching tuning as described in embodiments of the present disclosure. Main processor 340 can move data into or out of memory 360, as required by an executing process. In some embodiments, the main processor 340 is configured to execute a plurality of applications 362, such as applications for CoMP communications and MU-MIMO communications. The main processor 340 can operate the plurality of applications 362 based on OS program 361 or in response to a signal received from BS 102. Main processor 340 is also coupled to I/O interface 345. I/O interface 345 provides subscriber station 116 with the ability to connect to other devices such as laptop computers and handheld computers. I/O interface 345 is the communication path between these accessories and main controller 940.

Main processor 340 is also coupled to keypad 350 and display unit 355. The operator of subscriber station 116 uses keypad 950 to enter data into subscriber station 116. Display 355 may be a liquid crystal display capable of rendering text and/or at least limited graphics from web sites. Alternate embodiments may use other types of displays.

FIG. 4 illustrates a transmitter with an adaptive antenna matching tuning unit according to embodiments of the present disclosure. The embodiment of the transmitter 400 shown in FIG. 4 is for illustration only. Other embodiments of could be used without departing from the scope of the present disclosure.

As illustrated in FIG. 4, a transmitter 400 includes Power Amplifier (PA) 401, a coupler 402, a duplexer 403, a RF detector 404, a Tunable Matching Network (TMN) 405 and a tuning controller 413.

An RF signal amplified at the PA 401 is transmitted to the TMN 405 through the RF detector 404. The TMN 405 dynamically adjusts its internal impedance matching circuit to minimize the reflection of signal from the antenna under the control of the turning controller 413.

The RF detector 404 provides a signal reflected from an antenna 406 to a turning controller 413 through an Analog to Digital Converter (ADC) 412. The turning controller 413, implementing a tuning control algorithm, generates a control signal indicating whether and which changes are needed in the TMN 405, using the output of the RF detector 404, and passes the control signal to TMN 405. The TMN 405 carries out the change in the impedance matching under the control signal by varying the varactor capacitance or variable inductance. The transmitter 400 repeats this process until the desired impedance or voltage standing wave ratio (VSWR), for example, within VSWR of 2:1.

In certain embodiments, the RF detector 304 can be based on voltage standing wave ratio (VSWR). A VSWR detector can only provide the amplitude information, which is represented in a Γ circle on which the input impedance is located on Smith chart. This means that detection and tuning are done without crucial phase information of input impedance.

The optimization criteria based on VSWR detector output is minimizing VSWR (i.e., minimizing the reflection of signal), while the final ultimate matching goal is maximizing the power delivered to the load. In the case of a matching network without loss, tuning for achieving conjugation match or minimizing the reflection coefficient means maximizing the power transfer to the load. However, in reality, the matching network has a certain amount of loss and the above statements are no longer equivalent. Thus, any impedance matching approach or algorithm, in part or in whole, based on minimizing the input reflection coefficient, only has good accuracy for lossless and low loss matching networks or tuners.

However, the tuning control algorithm based on VSWR searches for the right component tuning setting through an iterative process, consuming a considerable amount of time to reach the tuning goal. In addition, depending on the optimizer choice and its initial settings, there is a risk of converging into local minima. Thus, it is desirable to develop a speed-up approach to directly compute, or based on a reasonable size look up table to get, the final component tuning setting for the impedance match in order to reduce the tuning time and avoid the intermediate tuning states.

The tunable matching networks (TMNs) have the critical advantage of changeable impedance behavior. Hence, if in addition, a feedback controller is implemented, the entire system can react adaptively to almost all impedance changes of the antenna depending on tunable matching networks conjugate coverage of antenna impedance Smith chart.

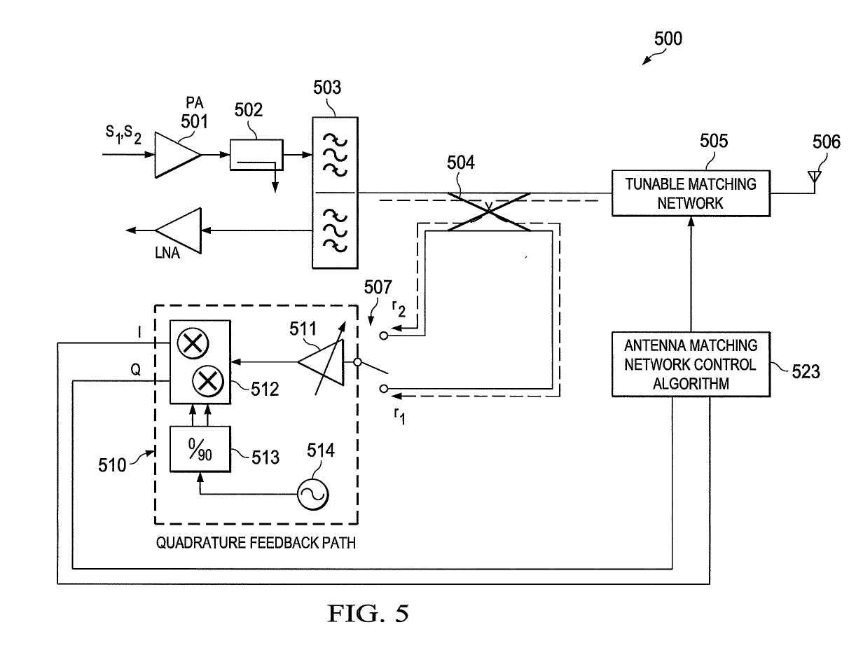

FIG. 5 illustrates a transmitter with qudrature feedback circuitry 510 according to embodiments of the present disclosure. The embodiment of the transmitter 500 shown in FIG. 5 is for illustration only. Other embodiments could be used without departing from the scope of the present disclosure.

Transmitter 500 includes a PA 501, a coupler 502, a duplexer 503, a bi-directional coupler 504, a tunable matching network 505 and a tuning controller 523. The tuning controller 523 is configured to implement an antenna matching network control algorithm.

An RF signal amplified at the PA 501 is transmitted to the TMN 505 through the coupler 502, the duplexer 503 and the bi-directional coupler 504. The TMN 505 dynamically adjusts its internal impedance matching circuit to minimize the reflected signal from antenna 506 under the control of the tuning controller 523.

The bi-directional coupler 504 provides a forward signal transmitted from PA 501 when the bi-direction coupler 504 is coupled to the forward path toward antenna 506. Alternatively, the bi-directional coupler 504 provides the reverse signal reflected from the antenna 506 when the bi-direction coupler 504 is coupled to the reverse path. A Single Pole, Double Throw (SPDT) switch 507 multiplexes the coupled forward path and the coupled reverse path to the quadrature feedback circuitry 510.

The signal provided from the bi-directional coupler 504 is amplified at Low Noise Amplifier (LNA) 511 and split into In-phase (I) and Quadrature (Q) signals by being mixed at a Mixer 512 with two reference frequencies with a 90° degree difference, which are generated from a local oscillator 514 and a phase shifter 513.

The tuning controller 523 receives both reflection coefficients amplitude and phase information from the outputs of the Mixer 512. The turning controller 523 receives the I/Q signals and implements the antenna matching network control algorithm described below to generate control signal indicating whether and which tunings are needed in the tunable matching circuit 505 of the antenna 506. With the radio output I/Q signals, turning controller 523 calculates both TMN input impedance's amplitude and phase through baseband signal processing, therefore pin-point the TMN input impedance in Smith chart to a point instead of a circle. Consequently, the tunable matching network 505 receiving the control signal from the tuning controller 523 carries out the change in the impedance matching under the control signal by varying the varactor capacitance or variable inductance.

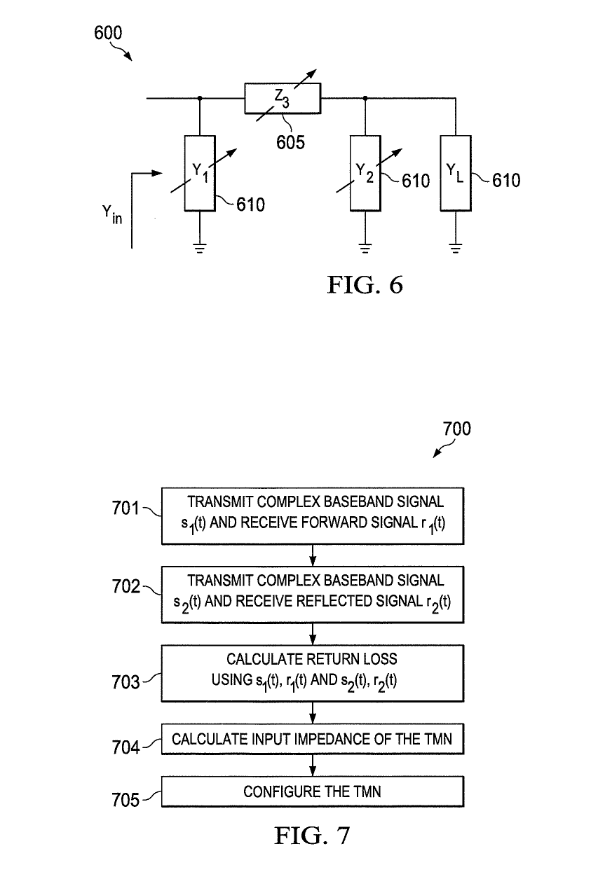

FIG. 6 illustrates a TMN circuitry according to embodiments of the present disclosure. The embodiment of the TMN circuitry 600 shown in FIG. 6 is for illustration only. Other embodiments could be used without departing from the scope of the present disclosure. The TMN circuitry 600 includes a plurality of variable impedances and configured as a pi-network circuit for impedance matching, so the input impedance at the TMN input can be inferred to the input port of antenna. For example, the TMN circuitry 600 can include a variable impedance 605 and a plurality of admittances 610.

FIG. 7 illustrates a high-level flow chart of a process for matching impedance according to embodiments of the present disclosure. While the flow chart depicts a series of sequential steps, unless explicitly stated no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

The process 700 begins with transmitting a complex baseband transmit signal s₁(t) to the PA 501 in step 701. The bi-directional coupler 504 switches to be coupled to the forward path to receive a signal r₁(t). Then the SPDT switch 507 switches on the down terminal and passes the signal r₁(t) to the quadrature feedback circuitry 510. The quadrature feedback circuitry 510 extracts I and Q signals from the signal r₁(t) and provides the I and Q signals to the turning controller 523 in which I and Q signals are stored forming a complex forward signal r₁(t).

In step 702, the process 700 transmits a complex baseband transmit signal s₂(t) to the PA 501. The bi-directional coupler 504 switches to be coupled to the reverse path to receive a signal r₂(t) reflected from the antenna. The SPDT switch 507 switches on the up terminal and passes the signal r₂(t) to the quadrature feedback circuitry 510. The quadrature feedback circuitry 510 extracts I and Q signals from the signal r₂(t) and provides the I and Q signals to the turning controller 523 where I and Q signals are stored forming a complex reflected signal r₂(t).

In step 703, the antenna matching network algorithm calculates the return loss S₁₁ of a complex coefficient at the input of TMN using Equation (1):

$${S}_{11} = \frac{{‖ {s}_{1} ( t ) ‖}^{2}}{{‖ {s}_{1} ( t ) ‖}^{2}} \frac{{s}_{2} ( t ) ⊗ {r}_{2} ( t )}{{s}_{1} ( t ) ⊗ {r}_{1} ( t )} \qquad Equation ( 1 )$$

where the symbol ‘ [symbol] ’ in Equation (1) represents cross-correlation.

The s₁(t) and s₂(t) can be normal in-operation transmitted signal; hence the scheme is fully compatible with in-network real-time operations.

In step 704, the input impedance Zᵢₙ of the TMN is calculated using Equation (2):

$${Z}_{in} = {Z}_{0} \cdot \frac{1 + {S}_{11}}{1 - {S}_{11}} \qquad Equation ( 2 )$$

where Z₀ is the characteristic internal impedance of the system. The process 700 can calculate both TMN input impedance's amplitude and phase with the I/Q signals, therefore pin-point the TMN input impedance in Smith chart to a point instead of a circle.

In embodiments where the TMN 505 adopts a pi-network TMN for impedance matching, with the calculated Yᵢₙ (=1/Zᵢₙ) using Equation (2), the load impedance Z_{L} (=1/Y_{L}) of the antenna is calculated from the input impedance of the pi-network TMN using Equation (3):

$${Y}_{L} = \frac{1}{\frac{1}{{Y}_{in} - {Y}_{1}} - {Z}_{3}} - {Y}_{2} \qquad Equation ( 3 )$$

where Y₁, Y₂ are variable admittances, and Z₃ is a variable impedance as illustrated in FIG. 6.

In embodiments, after knowing the load impedance of antenna, the process 500 refers to a Look Up Table (LUT) based on deterministic approach to map the variable impedances and admittances. The LUT maps the final coarse component tuning setting in order to reduce the tuning time and avoid the intermediate tuning states. The LUT is built with taking the TMN loss into consideration, hence the final coarse component setting is designed to maximize the relative transducer gain and the power delivered to antenna load. Once the final coarse component tuning setting is pin-pointed from the LUT, a fine step tuning around the final coarse component setting can be done to further improve the tuning accuracy and to mitigate the un-counted parasitic effect in the TMN de-embedding process. In other words, the un-counted parasitic effects in the lumped circuit model of TMN can cause inaccuracy of the de-embedding process, which can be tuned out through the fine tuning process.

Besides a LUT based deterministic approach, other direct calculation method can be used to compute the final component setting after knowing the load impedance of antenna.

Embodiments of the present disclosure facilitate adaptive antenna impedance matching by UE. Currently, due to smaller volume available to internal antenna design and increasing smart phone user interaction affecting antenna near field, there are increasing motivations to commercialize closed-loop antenna impedance matching in mobile terminals. Embodiments of the present disclosure use both amplitude and phase information; hence certain embodiments possess inherent advantage over prior arts with VSWR amplitude only detector. Embodiments of the present disclosure also use a LUT based method to directly map the final coarse component setting from the load impedance of antenna; hence avoiding lengthy iterative tuning process and avoiding possible convergence into local minima. Additionally, the LUT is built to maximize the transducer gain and the power delivered to the antenna load, hence the LUT is more desirable than minimizing VSWR in the sense of maximizing transmitter power efficiency and battery life.

It can be also contemplated that various combinations or subcombinations of the specific features and aspects of the embodiments may be made and still fall within the scope of the appended claims. For example, in some embodiments, the features, configurations, or other details disclosed or incorporated by reference herein with respect to some of the embodiments are combinable with other features, configurations, or details disclosed herein with respect to other embodiments to form new embodiments not explicitly disclosed herein. All of such embodiments having combinations of features and configurations are contemplated as being part of the present disclosure. Additionally, unless otherwise stated, no features or details of any of the stent or connector embodiments disclosed herein are meant to be required or essential to any of the embodiments disclosed herein, unless explicitly described herein as being required or essential.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for matching impedance for use in a wireless communication, comprising:
a forward path configured to carry a transmission signal to an antenna;
a quadrature feedback path configured to extract and feed back in-phase and quadrature phase components from each of a forward signal being transmitted toward the antenna and a reverse signal reflected from the antenna;
a tunable matching network (TMN) coupled to the forward path, having a plurality of tunable elements configured to match an internal impedance to an impedance of the antenna; and
a controller configured to calculate TMN input impedance's amplitude and phase based on the in-phase and quadrature phase components from each of the forward signal and the reverse signal.

2. The apparatus for matching impedance according to claim 1, wherein the forward path comprises a bi-directional coupler configured to provide either the forward signal or the reverse signal, with the quadrature feedback path.

3. The apparatus for matching impedance according to claim 2, wherein the bi-directional coupler is coupled to a Single Pole, Double Throw (SPDT) switch configured to multiplex the forward signal and the reverse signal to the quadrature feedback path.

4. The apparatus for matching impedance according to claim 1, wherein the quadrature feedback path comprises a mixer configured to extract the in-phase and quadrature phase components from the forward signal or the reverse signal.

5. The apparatus for matching impedance according to claim 1, wherein the controller is configured to transmit a first signal through the forward path and store the in-phase and quadrature phase components extracted from the forward signal corresponding to the first signal, and configured to transmit a second signal through the forward path and store the in-phase and quadrature phase components extracted from the reverse signal corresponding to the second signal.

6. The apparatus for matching impedance according to claim 5, the controller is configured to calculate a return loss S₁₁ using the following:
$${S}_{11} = \frac{{‖ {s}_{1} ( t ) ‖}^{2}}{{‖ {s}_{2} ( t ) ‖}^{2}} \frac{{s}_{2} ( t ) ⊗ {r}_{2} ( t )}{{s}_{1} ( t ) ⊗ {r}_{1} ( t )}$$
where s₁(t), s₂(t) are the first and second signals respectively, r₁(t) is the forward signal, and r₂(t) is the reverse signal.

7. The apparatus for matching impedance according to claim 6, wherein the controller is configured to calculate the input impedance Zₙ of the TMN using the following:
$${Z}_{in} = {Z}_{0} \cdot \frac{1 + {S}_{11}}{1 - {S}_{11}}$$
where Z₀ is the characteristic internal impedance.

8. The apparatus for matching impedance according to claim 7, wherein the TMN comprise a pi-network circuit, each branch of the pi-network circuit includes one or more elements with variable impedances or admittances.

9. The apparatus for matching impedance according to claim 8, wherein the controller is configured to calculate a load impedance of the antenna based on the input impedance of the TMN.

10. The apparatus for matching impedance according to claim 9, wherein the controller is configured to refer to a Look Up Table (LUT) to determine the variable impedances or admittances.

11. A method for matching impedance for use in a wireless communication, comprising:
detecting, on a forward path carrying a transmission to an antenna, a forward signal being transmitted toward the antenna and a reverse signal reflected from the antenna;
extracting and feeding back in-phase and quadrature phase components from each of the forward signal and the reverse signal via a quadrature feedback path;
calculating an amplitude and phase of input impedance of a tunable matching network (TMN) with a plurality of tunable elements, based on the in-phase and quadrature phase components from each of the forward signal and the reverse signal; and
configuring the TMN to have the determined input impedance's amplitude and phase by tuning the tunable elements.

12. The method for matching impedance according to claim 11, wherein the forward path comprises a bi-directional coupler configured to provide either the forward signal or the reverse signal, with the quadrature feedback path.

13. The method for matching impedance according to claim 12, wherein the bi-directional coupler is coupled to a Single Pole, Double Throw (SPDT) switch configured to multiplex the forward signal and the reverse signal to the quadrature feedback path.

14. The method for matching impedance according to claim 11, wherein the quadrature feedback path comprises a mixer configured to extract the in-phase and quadrature phase components from the forward signal and the reverse signal.

15. The method for matching impedance according to claim 11, wherein the controller is configured to transmit a first signal through the forward path and store the in-phase and quadrature phase components extracted from the first signal proceeding toward the antenna, and configured to transmit a second signal through the forward path and store the in-phase and quadrature phase components extracted from the second signal reflected from the antenna.

16. The method for matching impedance according to claim 15, further comprising calculating a return loss S₁₁ from the following:
$${S}_{11} = \frac{{‖ {s}_{1} ( t ) ‖}^{2}}{{‖ {s}_{2} ( t ) ‖}^{2}} \frac{{s}_{2} ( t ) ⊗ {r}_{2} ( t )}{{s}_{1} ( t ) ⊗ {r}_{1} ( t )}$$
where s₁(t), s₂(t) are the first and second signals respectively, r₁(t) is the forward signal, and r₂(t) is the reverse signal.

17. The method for matching impedance according to claim 16, wherein the input impedance Zᵢₙ of the TMN is calculated using the following:
$${Z}_{in} = {Z}_{0} \cdot \frac{1 + {S}_{11}}{1 - {S}_{11}}$$
where Z₀ is the characteristic internal impedance.

18. The method for matching impedance according to claim 17, wherein the TMN comprise a pi-network circuit, each branch of the pi-network circuit includes one or more elements with variable impedances or admittances.

19. The method for matching impedance according to claim 18, further comprising calculating a load impedance of the antenna based on the input impedance of the TMN.

20. The method for matching impedance according to claim 19, further comprising referring to a Look Up Table (LUT) to determine the variable impedances or admittances.
